(19) United States
(12) Patent Application Publication
(10) Pub. No.: US 2025/0376083 A1
(43) Pub. Date: Dec. 11, 2025

(54) SEAT CONTROL DEVICE AND SEAT CONTROL METHOD

(71) Applicant: TOYOTA BOSHOKU KABUSHIKI KAISHA, Aichi (JP)

(72) Inventors: Takahiro HARITA, Aichi (JP); Akio SHIMIZU, Aichi (JP)

(73) Assignee: TOYOTA BOSHOKU KABUSHIKI KAISHA, Aichi (JP)

(21) Appl. No.: 19/194,791

(22) Filed: Apr. 30, 2025

(30) Foreign Application Priority Data
Jun. 6, 2024 (JP) 2024-092477

(51) Int. Cl. B60N 2/02; B60N 2/50

(52) U.S. Cl. CPC B60N 2/0268; B60N 2/02258; B60N 2/50; B60N 2002/0216; B60N 2210/00

(57) ABSTRACT

A seat control device includes: a vehicle inclination sensor which obtains inclination information indicative of an inclination angle of a vehicle on which a seat is mounted with respect to a traveling surface; a rocking mechanism which rocks the seat; and a controller which controls the rocking mechanism, the controller executing a rocking adjustment process of adjusting rocking of the seat by driving the rocking mechanism on the basis of the obtained inclination information of the vehicle.

This Nonprovisional application claims priority under 35 U.S.C. § 119 on Patent Application No. 2024-092477 filed in Japan on Jun. 6, 2024, the entire contents of which are hereby incorporated by reference.

### TECHNICAL FIELD

The present disclosure relates to a seat control device and a seat control method.

### BACKGROUND ART

Patent Literature 1 discloses a system that is configured (a) to identify, on the basis of a geographical location, a road type or a current road region where a vehicle is traveling or identify a driving condition of the vehicle on the basis of the dynamics thereof, (b) to select a seat position predetermined according to the road type, the road region where the vehicle is traveling, or the driving condition, and (c) to control movement of the seat or movement of at least a part of the seat so as to obtain a selected seat position.

### CITATION LIST

### Patent Literature

### [Patent Literature 1]

Japanese Translation of PCT Patent Application Publication, Tokuhyo, No. 2023-505540

### SUMMARY OF INVENTION

### Technical Problem

However, since the above-described conventional technology selects the predetermined seat position and controls movement of the seat, it is difficult to control movement of the seat in accordance with a sequentially changing state of the moving body.

An aspect of the present disclosure is to provide a seat control device which controls movement of a seat in accordance with a sequentially changing state of a moving body, thereby giving a higher sleep induction effect than conventional.

### Solution to Problem

A seat control device in accordance with an aspect of the present disclosure is a seat control device which controls a seat on which a passenger riding on a moving body sits, the seat control device including: a first information obtaining section which obtains inclination information indicative of an inclination angle of the moving body, on which the seat is mounted, with respect to a traveling surface; a rocking mechanism, provided to the seat, which rocks the seat; and a controller which controls the rocking mechanism, the controller executing a rocking adjustment process of adjusting rocking of the seat by driving the rocking mechanism on a basis of the obtained inclination information of the moving body.

A seat control method in accordance with an aspect of the present disclosure is a seat control method which controls a seat on which a passenger riding on a moving body sits, the seat control method including: a first information obtaining step of obtaining inclination information indicative of an inclination angle of the moving body, on which the seat is mounted, with respect to a contact surface; and a rocking adjustment step of adjusting, on a basis of the obtained inclination information of the moving body, rocking of the seat by driving a rocking mechanism which is configured to rock the seat.

### ADVANTAGEOUS EFFECTS OF INVENTION

In accordance with an aspect of the present disclosure, it is possible to provide a seat control device which gives a higher sleep induction effect than conventional.

### BRIEF DESCRIPTION OF DRAWINGS

FIG. 1 is a view illustrating one example of an external appearance of a seat control device.

FIG. 2 is a view illustrating one example of a frame of a seat.

FIG. 3 is a view illustrating one example of rocking of the seat in a pitch direction.

FIG. 4 is a view schematically illustrating a rocking range observed when the seat starts rocking.

FIG. 5 is a flowchart illustrating a process carried out by the seat control device.

FIG. 6 is a sub-flowchart illustrating a rocking adjustment process illustrated in FIG. 5.

FIG. 7 is a view schematically illustrating an inclination angle of a vehicle 100 which is traveling on a slope.

### DESCRIPTION OF EMBODIMENTS

The following description will discuss an embodiment of the present disclosure in detail.

### Overview of Seat Control Device

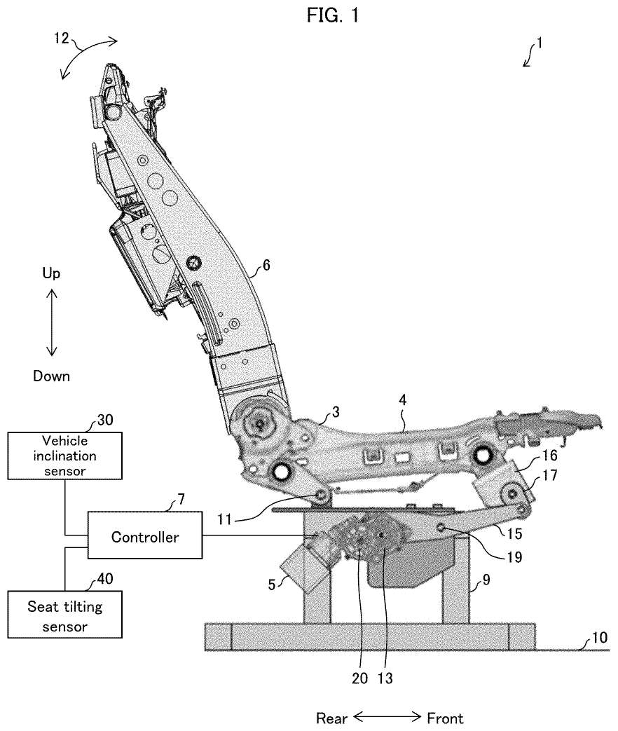

FIG. 1 is a view illustrating one example of an external appearance of a seat control device 1 in accordance with the present disclosure. As shown in FIG. 1, the seat control device 1 includes a seat 3, a motor 5, a controller 7, a vehicle inclination sensor 30, and a seat tilting sensor 40.

In the following description, it is assumed that a rightward direction in the example shown in FIG. 1 is the “front (forward)” of the seat 3, a leftward direction in the example shown in FIG. 1 is the “rear (rearward)” of the seat 3, a right side seen from the rear is a “rightward direction”, and a left side seen from the rear is a “leftward direction”. It should be noted directions indicate a relative positional relation in the example shown in FIG. 1 and the relative positional relation and the directions can vary depending on a direction in which the seat control device 1 is installed.

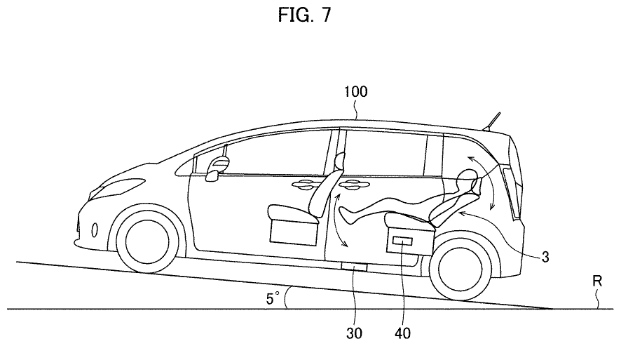

The seat 3 is a seat 3 on which a passenger riding on a vehicle 100 (see FIG. 7) sits, and is a support member for supporting the passenger's body. The “vehicle 100” is one example of a “moving body” of the present disclosure. The following description discusses an example in which the support member is the seat 3. However, this is not limitative. The support member may be a bed, a sofa, or other such members that a user can get onto.

The following description discusses an example in which the seat control device 1 is provided in the vehicle 100. Alternatively, the seat control device 1 may be provided to a moving body other than the vehicle 100. For example, the seat control device 1 may be provided in a taxi, a bus, a ship, an air craft, or the like. The present disclosure is not limited to the configuration in which the seat control device 1 is provided to a driver seat. Alternatively, the seat control device 1 may be provided to a passenger seat such as a front passenger seat and/or a rear seat(s).

### Rocking Mechanism

The seat 3 is provided with a rocking mechanism. The rocking mechanism is a mechanism for rocking the seat 3. The rocking mechanism includes a seating part 4, a back part 6, a motor 5, a base 9, a fulcrum 11, a sector gear 13, and a pinion gear 20.

The seat 3 is fixed on the base 9 via the fulcrum 11 serving as an axis. The seat 3 rocks about the fulcrum 11 in a pitch direction 12, that is, a front-rear direction. The “rocking” of the seat 3 means reciprocating motions in which a first motion and a second motion (each of which will be described later) of the seat 3 are alternately carried out repeatedly.

The rocking of the seat 3 brings about an effect of relaxing a passenger sitting on the seat 3 and an effect of stimulating the otoliths involved in passenger's sense of equilibrium and thereby to induce the passenger to sleep (hereinafter, this effect may sometimes be referred to as a “sleep induction effect”). Note that the direction of the rocking of the seat 3 is not limited to the pitch direction 12. Alternatively, the seat 3 may rock in a roll direction, that is, a left-right direction. Further, the seat 3 may rock both in the pitch direction 12 and the roll direction.

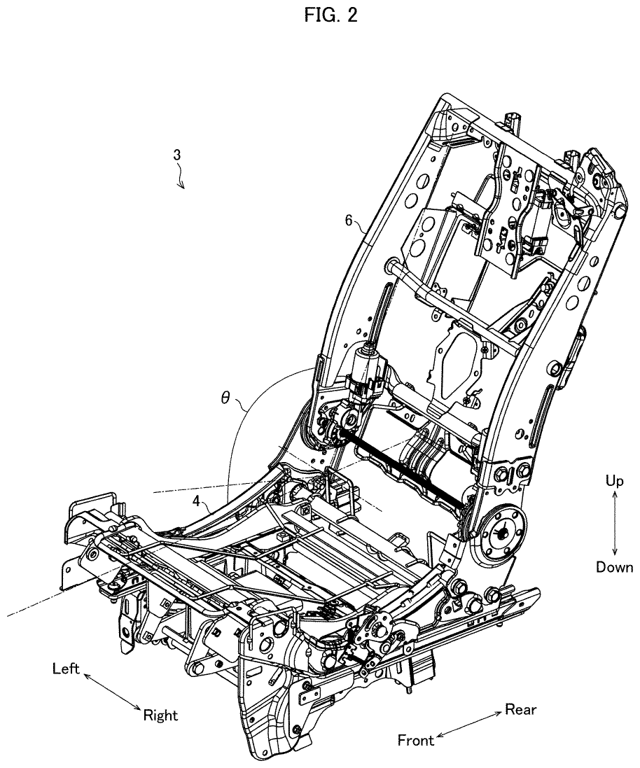

FIG. 2 is a view illustrating one example of a frame of the seat 3. The seat 3 includes the seating part 4 and the back part 6. An angle θ between the seating part 4 and the back part 6 can be adjusted by a reclining function.

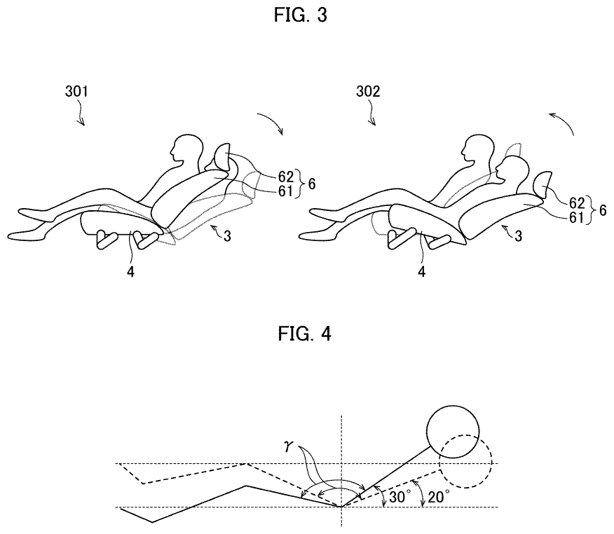

FIG. 3 is a view illustrating one example of the above-described rocking in the pitch direction 12. While rocking, the seat 3 alternately repeats a motion of titling rearward as illustrated in side view 301 and a motion of tilting forward as illustrated in side view 302. It is preferable, but not essential, that the rocking occurs in a state in which the angle θ between the seating part 4 and the back part 6 is fixed, as exemplified in FIG. 3. As one example, it is more preferable that the rocking occurs in a state in which the angle θ between the seating part 4 and the back part 6 is set and fixed at 135°. Note that the back part 6 of the seat 3 may include a seatback 61 and a headrest 62 as illustrated in the diagrams in FIG. 3.

In FIG. 1, the base 9, which is fixed to a floor surface 10, is provided with the motor 5 and a plurality of gears including the sector gear 13. Under control of the controller 7, the motor 5 causes a rotation shaft to rotate in a first rotation direction and a second rotation direction, which is opposite to the first rotation direction. With this operation, the motor 5 supplies motive power for rocking the seat 3 via the pinion gear 20, which is attached to the rotation shaft. As one example, the first rotation direction may be defined as leftward rotation (counterclockwise rotation) and the second rotation direction may be defined as rightward rotation (clockwise rotation), or vice versa.

### Vehicle Inclination Sensor

The vehicle inclination sensor 30 obtains inclination information indicative of an inclination angle of the vehicle 100 with respect to a traveling surface R (see FIG. 7). To be more specific, the vehicle inclination sensor 30 detects an inclination angle of the vehicle 100 with respect to the traveling surface R which inclination angle is observed while the vehicle 100 is traveling. The traveling surface R is one example of a contact surface for the vehicle 100. For example, the contact surface can be a surface of water in a case where the moving body is a ship, and the contact surface can be a runway in a case where the moving body is an air craft. Note that the vehicle inclination sensor 30 may detect an inclination angle of the vehicle 100 with respect to the traveling surface R which inclination angle is observed when the vehicle 100 is stopped, that is, a vehicle speed of the vehicle 100 is zero.

The vehicle inclination sensor 30 is one example of a first information obtaining section of the present disclosure. The vehicle inclination sensor 30 may be provided at an arbitrary position of the vehicle 100. The “arbitrary position” can be, for example, the seat 3 of the vehicle 100, the floor of the vehicle 100, or a door pillar of the vehicle 100.

The vehicle inclination sensor 30 sequentially measures an inclination angle of the vehicle 100 by detecting an acceleration and an angular velocity in directions of three axes and carries out arithmetic processing. The vehicle inclination sensor 30 may be constituted by a known device.

However, the present disclosure is not limited to the configuration in which the vehicle inclination sensor 30 sequentially measures the inclination angle of the vehicle 100 by detecting the acceleration and the angular velocity in the directions of the three axes and carries out the arithmetic processing. For example, the vehicle inclination sensor 30 may be configured to detect an inclination angle of the vehicle 100 with respect to a horizontal plane of a frame of a vehicle body of the vehicle 100. Further, the vehicle inclination sensor 30 may be a sensor which detects an inclination angle of the vehicle 100 on the basis of a change in direction of a gravitational acceleration with respect to the vehicle 100. In this case, the vehicle inclination sensor 30 may be constituted by a known device which is based on the MEMS technology.

In the present embodiment, the inclination angle of the vehicle 100 with respect to the traveling surface R includes two angles, that is, a roll angle of the vehicle 100 and a pitch angle of the vehicle 100. Further, the vehicle inclination sensor 30 may be configured to be capable of obtaining acceleration information indicative of one of (a) an acceleration of the vehicle 100 in the front-rear direction (pitch direction) and (b) an acceleration of the vehicle in the left-right direction (roll direction).

In the example illustrated in FIG. 1, a force is applied to a lower part of the seat 3 via a first plate 15 to which the sector gear 13 is fixed, a second plate 16, and a bracket 17. An angle between the first plate 15 and the second plate 16 and an angle between the second plate 16 and the bracket 17 are variable. The first plate 15 rotates in a given range, about a fulcrum point 19. In other words, when a front part of the first plate 15 is positioned higher, a rear part of the first plate 15 is positioned lower, and when the rear part of the first plate 15 is positioned higher, the front part of the first plate 15 is positioned lower. Left/right rotation of the sector gear 13 causes the front part of the first plate 15 to move up/down, such that the seat 3 repeats a back and forth motion with the fulcrum point 11 serving as an axis.

The seat control device 1 includes a lack and pinion mechanism which converts a rotation motion, in each direction, of the pinion gear 20 provided to the motor 5, into a linear motion that raises and lowers the front part of the seat 3. Thus, an upward force and a downward force are alternately applied to the lower part of the seat 3.

In accordance with rotation of the rotation shaft of the motor 5 in the first rotation direction, the seat 3 carries out the first motion of moving in a first movement direction. In accordance with rotation of the rotation shaft of the motor 5 in the second rotation direction, the seat 3 carries out the second motion of moving in a second movement direction. Note here that the movement includes a change only in the angle of the seat 3 with respect to the floor surface 10 on which the seat control device 1 is provided. The directions of the arrows for the pitch direction 12 in FIG. 1 are examples of the first movement direction and the second movement direction.

When the rotation shaft of the motor 5 rotates in the first rotation direction, the sector gear 13 rotates in a direction opposite to that when the rotation shaft of the motor 5 rotates in the second rotation direction. For example, in FIG. 1, in a case where the rotation shaft of the motor 5 rotates in the first rotation direction and the sector gear 13 rotates leftward (counterclockwise), the front part of the first plate 15 is lifted upward, and the seat 3 is tilted rearward. In this case, the rearward titling motion of the seat 3 is one example of the first motion in which the seat 3 moves in the first movement direction.

Meanwhile, in a case where the rotation shaft of the motor 5 rotates in the second rotation direction and the sector gear 13 rotates rightward (clockwise), the front part of the first plate 15 is pushed downward, and the seat 3 is tilted forward. In this case, the frontward titling motion of the seat 3 is one example of the second motion in which the seat 3 moves in the second movement direction.

In the present embodiment, the controller 7 is configured to control the rocking of the seat 3 such that a prescribed stopped period is provided between the first operation and the second operation. To be more specific, while rocking, the seat 3 temporarily stops at a time that the seat 3 makes a turn from the first movement direction to the second movement direction, which is opposite to the first movement direction. The “prescribed stopped period” is not limited to a certain period, and may be approximately 1 to 5 seconds, more desirably approximately 1 to 2 seconds or approximately 1 to 3 seconds.

A period in which an output torque of the motor 5 is zero in the prescribed stopped period may be considered as being included in the stopped period, even if the seat 3 slightly moves due to inertia. Providing a stopped period in the rocking makes it possible to suppress overheating of the motor 5. However, this configuration is not essential. That is, the prescribed stopped period may not be provided between the first motion and the second motion.

### Seat Tilting Sensor

The seat tilting sensor 40 obtains seat tilting information indicative of an inclination angle of the seat 3 with respect to a mounting surface on which the seat 3 is mounted. To be more specific, the seat tilting sensor 40 detects an inclination angle of the seat 3, that is, an inclination angle of the frame of the seat 3. The seat tilting sensor 40 is one example of a second information obtaining section in accordance with the present disclosure. The seat tilting sensor 40 may be provided at an arbitrary position of the vehicle 100, similarly to the vehicle inclination sensor 30.

Further, similarly to the vehicle inclination sensor 30, the seat tilting sensor 40 sequentially measures an inclination angle of the seat 3 by detecting an acceleration and an angular velocity in the directions of the three axes and carrying out the arithmetic processing. The seat tilting sensor 40 may be constituted by a known device.

The seat tilting sensor 40 may be a sensor which detects an inclination angle of the seat on the basis of a change in direction of a gravitational acceleration with respect to the vehicle 100. In this case, the seat tilting sensor 40 may be constituted by a known device which is based on the MEMS technology.

In present embodiment, the vehicle inclination sensor 30 and the seat tilting sensor 40 may be provided as separate members. However, this is not limitative. The vehicle inclination sensor 30 and the seat tilting sensor 40 may be provided as a single sensor. In a case where the vehicle inclination sensor 30 and the seat tilting sensor 40 are provided as a single sensor, the single sensor may be configured to be capable of obtaining an inclination angle of the vehicle 100 with respect to the traveling surface R and an inclination angle of the seat 3 with respect to the mounting surface on which the seat 3 is mounted.

### Rocking Range of Seat

The following description will discuss, with reference to FIG. 4, a rocking range of the seat 3. FIG. 4 is a view schematically illustrating a rocking range observed when the seat 3 starts rocking. In FIG. 4, for easy understanding of the rocking range (rocking angle), the seat 3 is not illustrated.

While the seat 30 is rocking under control of the seat control device 1 in accordance with the present disclosure, a hip angle γ is preferably fixed at “135°”, as shown in FIG. 4. The hip angle γ is an angle θ between the seating part 4 and the back part 6. In the following description, a state in which the back part 6 is tilted, by the reclining function, so as to be located rearward of a position of a sitting posture of a passenger who is driving is defined as a “sleeping posture state”. Examples of the sleeping posture state include a state in which the back part 6 is tilted so as to be located rearward of a position of a sitting posture of a passenger who sits on the front passenger seat or the rear seat, as well as that for the sitting posture of the passenger who is driving. Examples of the sleeping posture state also include a maximum reclined position (a furthest back position of the back part 6) obtained by the reclining function.

In the sleeping posture state, the seat 3 rocks between a first tilted position (the passenger's position indicated by the solid line shown in FIG. 4) and a second tilted position (the passenger's position indicated by the broken line in FIG. 4). The “first tilted position” refers to a position of the back part 6 relative to the mounting surface (floor surface 10) on which the seat 3 is mounted, given that an angle between the back part 6 and the floor surface 10 observed when the seating part 4 and the back part 6 are positioned so as to become flat with respect to the floor surface 10 is zero. To be more specific, the first tilted position refers to a position of the back part 6 raised closer to the seating part 4 than in the second tilted position, and an inclination angle of the seat 3 in the first tilted position is 30°, for example.

The “second tilted position” refers to a position of the back part 6 raised from the mounting surface (floor surface 10) on which the seat 3 is mounted.

To be more specific, the second tilted position refers to a position of the back part 6 tilted closer to the mounting surface than in the first tilted position, and an inclination angle of the seat 3 in the second tilted position is 20°, for example. In other words, the position of the seat 3 in the first tilted position can be expressed as a position of the back part 6 tilted so that an angle between the mounting surface (floor surface 10) and the back part 6 becomes 150°. Further, the position of the seat 3 in the second tilted position can be expressed as a position of the back part 6 tilted so that an angle between the mounting surface (floor surface 10) and the back part 6 becomes 160°.

In order to enhance the sleep induction effect for a passenger, an allowable rocking range may be set for each of the first tilted position and the second tilted position. For example, in a case where the hip angle γ is 135°, a maximum value of the inclination angle in the first tilted position is set at 30°. Further, a minimum value of the inclination angle in the second tilted position is set at 20°. That is, in a case where the hip angle γ is 135°, the allowable rocking range of the seat 3 is in a range from 30° to 20° with respect to the mounting surface (floor surface 10) on which the seat 3 is mounted. The rocking of the seat 3 is carried out within this range.

Note that the angle of 30° in the first tilted position and the angle of 20° in the second tilted position are merely one example. These angles may be changed appropriately on the basis of passenger's personal data, for example. The “passenger's personal data” is, for example, information such as identification information (e.g., an age, a gender, etc.) and health information (e.g., a somatotype, a heart rate, a body temperature, etc.)

In each of the first tilted position and the second tilted position, it is preferable that the lower limbs of the passenger be positioned lower than the head of the passenger. This is because positioning the lower limbs higher than the head makes it difficult to yield the sleep induction effect. Further, the above-described hip angle γ is not limited to 135°. The hip angle γ may be set appropriately within a range in which the passenger's lower limbs are positioned lower than the head.

### Flow of Process by Seat Control Device

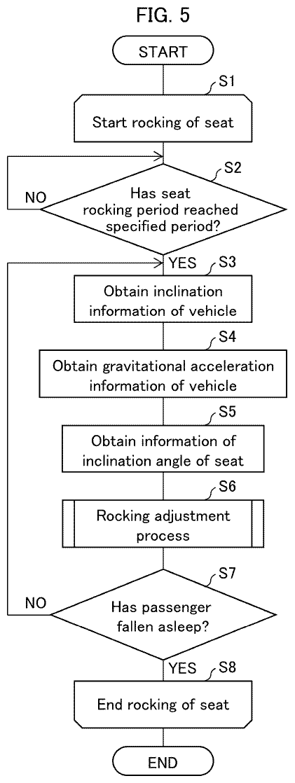

The following description will discuss, with reference to FIG. 5, a flow of a process carried out by the seat control device 1. FIG. 5 is a flowchart illustrating a process carried out by the seat control device. As a premise under which each step is explained, rocking of the seat 3 in accordance with the present embodiment is carried out in the sleeping posture state.

In step S1, the controller 7 drives the motor to start rocking the seat 3. Either in a case where the seat 3 is to be brought into the sleeping posture state or in a case where the seat 3 is to start rocking in step S1, this can be executed by pressing a button provided to the vehicle 100. For example, when the seat 3 is at a seat position at which the passenger drives, pressing the button provided to the vehicle 100 may cause a transition of the seat position into the sleeping posture state; then, the rocking may be started subsequently to the transition of the seat position into the seat position.

Further, the transition of the seat position into the sleeping posture state may be adjusted and executed by the passenger's manual operation of the reclining function for the seat 3. Alternatively, the transition of the seat 3 into the sleeping posture state or the start of rocking may be carried out via a mobile terminal, such as a smartphone or a laptop computer, through short range communication between the mobile terminal and a communication section provided in the vehicle 100.

In step S2, after rocking of the seat 3 is started, the controller 7 executes a process of determining whether or not a rocking period of the seat 3 has reached a specified period. The specified period is stored in a storage device (e.g., a memory) provided in the vehicle 100, for example. The controller 7 determines, on the basis of the specified period stored in the memory, whether or not the rocking period has reached the specified period. The specified period is appropriately set within a range from 5 minutes to 15 minutes, for example. However, this is not limitative. The specified period may be set so as to be less than 5 minutes or not less than 16 minutes.

In a case where the controller 7 determines, in step S2, that the rocking period of the seat 3 has not reached the specified period (step S2: NO), the rocking of the seat 3 is continued until the rocking period of the seat 3 reaches the specified period.

Meanwhile, in a case where the controller 7 determines, in step S2, that the rocking period of the seat 3 has reached the specified period (step S2: YES), the controller 7 obtains, in step S3, inclination information indicative of an inclination angle of the vehicle 100 with respect to the traveling surface which inclination information has been obtained by the vehicle inclination sensor 30.

Further, in step S4, the controller 7 obtains acceleration information indicative of (a) an acceleration of the vehicle 100 in the front-rear direction (pitch direction) and (b) an acceleration of the vehicle in the left-right direction (roll direction) which acceleration information has been obtained by the vehicle inclination sensor 30.

Further, in step S5, the controller 7 obtains seat tilting information indicative of an inclination angle of the seat 3 with respect to the mounting surface (floor surface 10) on which the seat 3 is mounted which seat tilting information has been obtained by the seat tilting sensor 40.

In step S6, the controller 7 executes a rocking adjustment process on the basis of the above-described inclination information, acceleration information, and seat tilting information having been obtained. Details of the rocking adjustment process will be described later.

In step S7, the controller 7 executes a process of determining whether or not the passenger sitting on the seat 3 has fallen asleep. The determination of whether or not the passenger has fallen asleep may be executed on the basis of information detected by a known device. The detected information may include biological information of the passenger. The biological information of the passenger includes, for example, at least one selected from the group consisting of pieces of biological information related to sleepiness, such as a heart rate, an electroencephalogram, a pulse wave, a frequency of blink, and Percent of Eyelid Closure (PERCLOS) of the passenger.

For example, the known device may be any device, provided that it is a device which can detect sleepiness of the passenger, e.g., a Driver Monitoring System (DMS) constituted by an in-vehicle camera and/or the like, and a drive recorder, a wearable device such as a smart watch.

Alternatively, the determination of whether or not the passenger has fallen asleep may be made by carrying out short range communication with a device such as a smartphone or a wearable device capable of obtaining biological information and obtaining information from the device. Then, in a case where the controller 7 determines that the passenger has fallen asleep (step S7: YES), the rocking of the seat 3 is ended (step S8).

Meanwhile, in a case where the controller 7 determines that the passenger has not fallen asleep (step S7: NO), the processes of steps S3 to S6 will be executed repeatedly.

### Rocking Adjustment Process

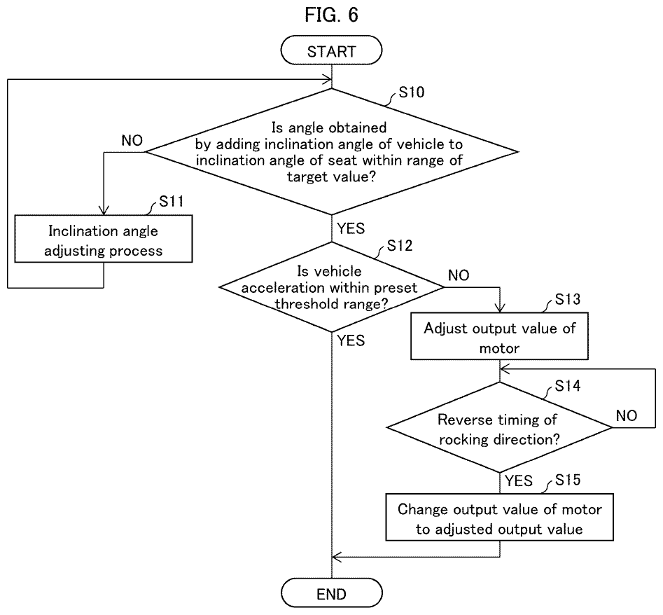

The following will describe details of the above-described rocking adjustment process with reference to FIGS. 6 and 7. FIG. 6 is a sub-flowchart illustrating the rocking adjustment process illustrated in FIG. 5. FIG. 7 is a view schematically illustrating an inclination angle of the vehicle 100 which is traveling on a slope.

When the controller 7 executes the rocking adjustment process in the above-described step S6, the controller 7 executes, in step S10, a “rocking range determination process” of determining whether or not an angle obtained by adding the inclination angle of the vehicle 100 to the inclination angle of the seat 3 is within a range of target values.

The “target values” are numerical values each of which is set as an angle of rocking the seat 3. To be more specific, the target values are numerical values obtained by combining the above-described rocking range with a width of rocking. The “width of rocking” is a range of an angle between the first tilted position and the second tilted position of the seat 3, which have been set within the rocking range of the seat 3. Note that the target values may be stored in the storage device (for example, a memory).

In the example illustrated in FIG. 4, in a case where the hip angle γ is 135°, a range of 10° is set as a width of rocking, the range of 10° being a difference between (a) 30° which is the inclination angle of the seat 30 in the first tilted position and (b) 20° which is the inclination angle of the seat 30 in the second tilted position. Note that a more preferable width of rocking is 8°.

For example, the following will discuss the case illustrated in FIG. 7, in which the vehicle 100 is traveling on a traveling surface R having an inclination angle of 5°. It is assumed that, as target values for the seat 3 shown in FIG. 7, (a) a rocking range in which an inclination angle of the seat 3 in the first tilted position is not more than 30° and an inclination angle of the seat 3 in the second tilted position is not less than 20° is set and (b) a width of rocking of 8° to 10° is set.

(1) A case where the vehicle travels on the slope with a seat position being set so that an inclination angle of the seat 3 in the first tilted position is 35° (an angle between the mounting surface (floor surface 10) and the back part 6 is 145°) and an inclination angle of the seat 3 in the second tilted position is 25° (an angle between the mounting surface (floor surface 10) and the back part 6 is 155°).

In this case, an angle obtained by adding the inclination angle of the vehicle 100 to the inclination angle of the seat 3 is 150° for the first tilted position, and is 160° for the second tilted position. That is, (a) a rocking range with an inclination angle being 30° in the first tilted position and an inclination angle being 20° in the second tilted position and (b) a width of rocking being 10° are set. Thus, the controller 7 determines that the angle obtained by adding the inclination angle of the vehicle 100 to the inclination angle of the seat 3 is within a range of the target values (step S10: YES).

(2) A case where the vehicle travels on the slope with a seat position being set so that an inclination angle of the seat 3 in the first tilted position is 30° (an angle between the mounting surface (floor surface 10) and the back part 6 is 150°) and an inclination angle of the seat 3 in the second tilted position is 20° (an angle between the mounting surface (floor surface 10) and the back part 6 is 140°).

In this case, an angle obtained by adding the inclination angle of the vehicle 100 to the inclination angle of the seat 3 is 155° for the first tilted position, and 145° for the second tilted position. That is, (a) a rocking range with an inclination angle being 25° in the first tilted position and an inclination angle being 15° in the second tilted position and (ii) a width of rocking being 10°. Therefore, the inclination angle of the seat 3 in the first tilted position is within the range of the target values, but the inclination angle of the seat 3 in the second tilted position is outside the range of the target values. Thus, the controller 7 determines that the angle obtained by adding the inclination angle of the vehicle 100 to the inclination angle of the seat 3 is outside the range of the target values (step S10: NO).

In a case where the controller 7 determines, in step S10, that the angle obtained by adding the inclination angle of the vehicle 100 to the inclination angle of the seat 3 is outside the range of the target values, the controller 7 executes, in step S11, an “inclination angle adjusting process” of adjusting the inclination angle of the seat 3.

For example, in the case of (2) described above, the seat 3 in the second tilted position indicates the seat 3 is too tilted, and therefore the angle is adjusted so that the inclination angle of the seat 3 in the second tilted position is not less than 20°. The adjustment of the angle of the seat 3 is carried out by, for example, the controller 7 driving the motor 5 to adjust the angle of the seat 3 in the second tilted position. Then, the controller 7 executes the inclination angle adjusting process, and thereafter executes the process in step S10 again.

Meanwhile, in a case where the controller 7 determines, in step S10, that the angle obtained by adding the inclination angle of the vehicle 100 to the inclination angle of the seat 3 is within the range of the target values, the controller 7 executes an “acceleration determination process” in step S12. The “acceleration determination process” is a process of determining whether or not an acceleration indicative of the acceleration information obtained by the vehicle inclination sensor 30 is within a prescribed threshold range. The “prescribed threshold range” is, for example, a range defined by numerical values of 0.01 m/s² to 0.06 m/s², more preferably a range defined by numerical values of 0.01 m/s² to 0.02 m/s².

In a case where the controller 7 determines that the acceleration of the vehicle 100 is within the prescribed threshold range (step S12: YES), the rocking adjustment process is completed. When the rocking adjustment process is completed, the rocking of the seat 3 continues, and the process advances to step S7.

Meanwhile, in a case where the controller 7 determines that the acceleration of the vehicle 100 is outside the prescribed threshold range (step S12: NO), the controller 7 adjusts the rocking speed of the seat 3 by adjusting an output value of the motor 5 in step S13. The adjustment of the rocking speed is carried out on the basis of the acceleration information.

For example, when a brake pedal of the vehicle 100 is pressed and the traveling speed of the vehicle 100 decreases, an acceleration occurs in a direction from the front side toward the rear side of the vehicle 100. In this case, the direction of the second motion in which the seat 3 moves in the second movement direction (forward) is a direction cancelling the acceleration. Meanwhile, when an accelerator pedal of the vehicle 100 is pressed and the traveling speed of the vehicle 100 increases, an acceleration occurs in a direction from the rear side toward the front side of the vehicle 100. In this case, the direction of the first motion in which the seat 3 moves in the first movement (rearward) is a direction cancelling the direction acceleration.

By adjusting the output value of the motor 5 in the direction cancelling the acceleration in this manner, the acceleration occurring in the vehicle 100 is canceled and the rocking speed can be stabilized.

In step S14, the controller 7 determines whether or not it is a reverse timing that a rocking direction (the pitch direction 12, i.e., the front-rear direction) is reversed. The “reverse timing” is a timing that after completion of rocking of the seat 3 in the first movement direction and before start of rocking of the seat 3 in the second movement direction, which is different from the first movement direction. To be more specific, the reverse timing is a timing that, while rocking, the seat 3 temporarily stops when the seat 3 makes a turn from the first movement direction to the second movement direction, which is opposite to the first movement direction. Note that the reverse timing can also be a timing which is before the seat starts rocking in the first movement direction after rocking in the second movement direction.

In a case where the controller 7 determines that it is the reverse timing of the rocking direction (step S14: YES), the controller 7 changes the output value of the motor 5 to the output value having been adjusted in step S13 (step S15). Then, the rocking adjustment process is completed. When the rocking adjustment process is completed, the rocking of the seat 3 continues, and the process advances to step S7.

Meanwhile, in a case where the controller 7 determines that it is not the reverse timing of the rocking direction (step S14: NO), the controller 7 repeats the process in step S14 until the reverse timing of the rocking direction comes.

### Variations

The below-described variations are applicable to the present embodiment as appropriate. Further, the variations can be implemented in combination, as long as this does not cause technical contradiction.

### Frist Variation

In the description of the foregoing embodiment, the rocking direction of the seat 3 is the pitch direction. However, the rocking direction of the seat 3 is not limited to the pitch direction. For example, the rocking direction of the seat 3 may be the roll direction. For another example, the roll direction may be a direction obtained by combining the pitch direction and the roll direction together.

### Second Variation

In the foregoing embodiment, the rocking range determination process (step S10) and the inclination angle adjusting process (step S11) are executed on the basis of the information obtained by the vehicle inclination sensor 30 and the seat tilting sensor 40. However, this not limitative. Instead of the vehicle inclination sensor 30 and the seat tilting sensor 40, an Occupant Classification System (OCS) may be used. To be more specific, target values may be set by assuming a rocking range and a width of rocking on a basis of (a) a load distribution of a passenger sitting on the seat 3 and (b) a load distribution of the passenger who is in the sleeping posture state.

For example, the load distribution of the passenger may be detected by a pressure sensor(s) provided to the seating part 4, a cushion part of the back part 6, the frame of the seat 3, and/or the like. For another example, the load distribution of the passenger may be detected by capacitive sensors provided to a surface of the seating part 4 and a surface of the back part 6. Note that there is no particular limitation on a device for carrying out the detection, provided that it is capable of detecting the load distribution of the passenger.

With the configuration in accordance with the present variation, it is possible to execute the rocking range determination process (step S10) and the inclination angle adjusting process (step S11), even if the vehicle inclination sensor 30 and the seat tilting sensor 40 are not provided.

### Effects

As discussed above, the present embodiment provides the following effects.

A seat control device 1 in accordance with a first aspect of the present disclosure is a seat control device 1 which controls a seat 3 on which a passenger riding on a moving body (vehicle 100) sits, the seat control device 1 including: a first information obtaining section (vehicle inclination sensor 30) which obtains inclination information indicative of an inclination angle of the moving body (vehicle 100), on which the seat 3 is mounted, with respect to a traveling surface R; a rocking mechanism, provided to the seat 3, which rocks the seat 3; and a controller 7 which controls the rocking mechanism, the controller 7 executing a rocking adjustment process of adjusting rocking of the seat 3 by driving the rocking mechanism on a basis of the obtained inclination information of the moving body (vehicle 100).

With the above configuration, it is possible to obtain the inclination information of the moving body (vehicle 100) provided with the rocking mechanism. Further, the controller 7 can execute, on the basis of the obtained inclination information of the moving body (vehicle 100), the rocking adjustment process of adjusting the rocking of the seat 3. Consequently, it is possible to cause the rocking mechanism to carry out the rocking in a certain range in accordance with a sequentially changing state of the moving body (vehicle 100). Therefore, it is possible to provide the seat control device 1 which gives a higher sleep induction effect than conventional.

A seat control device 1 in accordance with a second aspect of the present disclosure may be configured such that, in the first aspect, the inclination information of the moving body (vehicle 100) is obtained from the moving body (vehicle 100) which is traveling.

With the above configuration, it is possible to obtain the inclination information from the moving body (vehicle 100) which is traveling. Consequently, during traveling of the moving body (vehicle 100), during which a higher sleep induction effect can be expected than during stopping, it is possible to obtain sequentially changing inclination information of the moving body (vehicle 100) and execute the rocking adjustment process. This can further enhance the sleep induction effect.

A seat control device 1 in accordance with a third aspect of the present disclosure may be configured such that, in the first aspect, the rocking adjustment process includes a process of adjusting a rocking speed of the seat 3 by driving the rocking mechanism on a basis of the obtained inclination information of the moving body (vehicle 100).

With the above configuration, it is possible to adjust the rocking of the seat 3 in consideration of the rocking speed of the seat 3. This can further enhance the sleep induction effect.

A seat control device 1 in accordance with a fourth aspect of the present disclosure may be configured such that, in the third aspect, information obtained by the first information obtaining section includes acceleration information indicative of one of (a) an acceleration of the moving body (vehicle 100) in a front-rear direction and (b) an acceleration of the moving body (vehicle 100) in a left-right direction; and the rocking adjustment process includes a process of adjusting the rocking speed of the seat 3 on a basis of the obtained acceleration information of the moving body (vehicle 100).

With the above configuration, it is possible to adjust the rocking speed of the seat 3 in consideration of the acceleration information. Thus, for example, the rocking speed of the seat 3 is also adjusted in acceleration/deceleration of the moving body (vehicle 100). This facilitates the passenger to feel a certain acceleration, thereby making it possible to further enhance the sleep induction effect.

A seat control device 1 in accordance with a fifth aspect of the present disclosure may be configured such that, in the fourth aspect, the rocking adjustment process includes an acceleration determination process of determining whether or not the acceleration indicated by the obtained acceleration information is within a prescribed threshold range.

With the above configuration, it is determined, in adjusting the rocking speed of the seat 3, whether or not the acceleration is within the prescribed threshold range. Thus, if the acceleration is within the threshold range, it is possible to continuously carry out the rocking without adjusting the rocking speed of the seat 3. Meanwhile, if the acceleration is outside the threshold range, it is possible to adjust the rocking speed of the seat 3. Thus, the rocking speed of the seat 3 is adjusted only when the adjustment of the rocking speed of the seat 3 is necessary. This hardly gives an uncomfortable feeling to the passenger. This facilitates the passenger to feel a certain acceleration, thereby making it possible to further enhance the sleep induction effect.

A seat control device 1 in accordance with a sixth aspect of the present disclosure may be configured such that, in any one of the third to fifth aspects, the adjustment of the rocking speed is executed after completion of rocking of the seat 3 in a first movement direction and before start of rocking of the seat 3 in a second movement direction, which is different from the first movement direction.

With the above configuration, the adjustment of the rocking speed is executed at a timing after completion of rocking of the seat 3 in the first movement direction and before start of rocking of the seat 3 in the second movement direction. Generally, it can be expected that rocking the seat 3 in a constant rhythm provides further enhancement of the sleep induction effect. By controlling the rocking timing for the seat 3 as in the above configuration, it is possible to make it difficult for the passenger to feel a change in the rhythm. Therefore, even in a case where the rocking speed is adjusted, the passenger feels rocking in a certain rhythm. This makes it possible to further enhance the sleep induction effect.

A seat control device 1 in accordance with a seventh aspect of the present disclosure may be configured such that, in the first aspect, the seat control device 1 further includes: a second information obtaining section (seat tilting sensor 40) which obtains seat tilting information indicative of an inclination angle of the seat 3 with respect to a mounting surface on which the seat 3 is mounted, the controller 7 executing a rocking range determination process of determining whether or not an angle obtained by adding, to the inclination angle of the seat 3 which inclination angle is indicated by the obtained seat tilting information, the inclination angle of the moving body (vehicle 100) which inclination angle is indicated by the obtained inclination information is within a range of target values having been set as an angle of rocking the seat 3.

With the above configuration, it is possible to obtain the inclination angle of the seat 3. Further, it is possible to determine whether or not the angle obtained by adding the inclination angle of the moving body (vehicle 100) to the obtained inclination angle of the seat 3 is within the range of the target values having been set for an angle of rocking the seat 3. This makes it possible to cause the seat control device 1 to execute rocking having a high sleep induction effect.

A seat control device 1 in accordance with an eighth aspect of the present disclosure may be configured such that, in the seventh aspect, in a case where it is determined, in the rocking range determination process, that the angle obtained by adding, to the inclination angle of the seat 3 which inclination angle is indicated by the obtained tilting information, the inclination angle of the moving body (vehicle 100) which inclination angle is indicated by the obtained inclination information is within the range of the target values, the controller 7 drives the rocking mechanism to execute rocking of the seat 3; and in a case where it is determined, in the rocking range determination process, that the angle obtained by adding, to the inclination angle of the seat 3 which inclination angle is indicated by the obtained seat tilting information, the inclination angle of the moving body (vehicle 100) which inclination angle is indicated by the obtained inclination information is outside the range of the target values, the controller 7 executes an inclination angle adjusting process of adjusting the inclination angle of the seat 3.

With the above configuration, in a case where the angle obtained by adding the inclination angle of the moving body (vehicle 100) to the obtained inclination angle of the seat 3 is outside the range of the target values having been set for an angle of rocking the seat 3, that is, in a case where there is a possibility that the sleep induction effect is low, it is possible to adjust the inclination angle of the seat 3. Consequently, even in a case where the moving body (vehicle 100) is inclined, e.g., while the moving body is traveling on a slope, it is possible to adjust the inclination angle of the seat 3. This makes it possible to cause the seat control device 1 to execute rocking having a high sleep induction effect.

A seat control method in accordance with a ninth aspect of the present disclosure is a seat control method which controls a seat 3 on which a passenger riding on a moving body (vehicle 100) sits, the seat control method including: a first information obtaining step (steps S3 and S4) of obtaining inclination information indicative of an inclination angle of the moving body (vehicle 100), on which the seat 3 is mounted, with respect to a traveling surface; and a rocking adjustment step (step S6) of adjusting, on a basis of the obtained inclination information of the moving body (vehicle 100), rocking of the seat 3 by driving a rocking mechanism which is configured to rock the seat 3.

### Software Implementation Example

The functions of the seat control device 1 (hereinafter referred to as a “device”) can be realized by a program for causing a computer to function as the device, the program causing the computer to function as the control blocks of the device.

In this case, the device includes a computer that has at least one control device (for example, a processor) and at least one memory device (for example, a memory) as hardware for executing the program. The control device and the storage device execute the program, so that the functions described in the above embodiments are realized.

The program can be stored in one or more non-transitory computer-readable storage media. The storage medium can be provided in the device, but the storage medium does not need to be provided in the device. In the latter case, the program can be supplied to the device via any wired or wireless transmission medium.

A part or all of the functions of the control blocks can be realized by a logic circuit. For example, an integrated circuit in which a logic circuit that functions as each of the control blocks is formed is also encompassed in the scope of the present disclosure. In addition, the function of each of the control blocks can be realized by, for example, a quantum computer.

Further, each of the processes described in the above embodiments can be executed by artificial intelligence (AI). In this case, the AI may be operated by the control device or may be operated by another device (for example, an edge computer and a cloud server).

The present disclosure is not limited to the embodiments described above, but can be altered within the scope of the claims. The present disclosure also encompasses, in its technical scope, any embodiment derived by combining technical means disclosed in differing embodiments.

### REFERENCE SIGNS LIST

1: seat control device
3: seat
7: controller
30: vehicle inclination sensor (first information obtaining section)
40: seat tilting sensor (second information obtaining section)
100: vehicle

1. A seat control device which controls a seat on which a passenger riding on a moving body sits, the seat control device comprising:
a first information obtaining section which obtains inclination information indicative of an inclination angle of the moving body, on which the seat is mounted, with respect to a contact surface;
a rocking mechanism, provided to the seat, which rocks the seat; and
a controller which controls the rocking mechanism,
the controller executing a rocking adjustment process of adjusting rocking of the seat by driving the rocking mechanism on a basis of the obtained inclination information of the moving body.

2. The seat control device according to claim 1, wherein:
the inclination information of the moving body is obtained from the moving body which is traveling.

3. The seat control device according to claim 1, wherein:
the rocking adjustment process includes a process of adjusting a rocking speed of the seat by driving the rocking mechanism on a basis of the obtained inclination information of the moving body.

4. The seat control device according to claim 3, wherein:
information obtained by the first information obtaining section includes acceleration information indicative of one of (a) an acceleration of the moving body in a front-rear direction and (b) an acceleration of the moving body in a left-right direction; and
the rocking adjustment process includes a process of adjusting the rocking speed of the seat on a basis of the obtained acceleration information of the moving body.

5. The seat control device according to claim 4, wherein:
the rocking adjustment process includes an acceleration determination process of determining whether or not the acceleration indicated by the obtained acceleration information is within a prescribed threshold range.

6. The seat control device according to claim 3, wherein:
the adjustment of the rocking speed is executed after completion of rocking of the seat in a first movement direction and before start of rocking of the seat in a second movement direction, which is different from the first movement direction.

7. The seat control device according to claim 1, further comprising:
a second information obtaining section which obtains seat tilting information indicative of an inclination angle of the seat with respect to a mounting surface on which the seat is mounted,
the controller executing a rocking range determination process of determining whether or not an angle obtained by adding, to the inclination angle of the seat which inclination angle is indicated by the obtained seat tilting information, the inclination angle of the moving body which inclination angle is indicated by the obtained inclination information is within a range of target values having been set as an angle of rocking the seat.

8. The seat control device according to claim 7, wherein:
in a case where it is determined, in the rocking range determination process, that the angle obtained by adding, to the inclination angle of the seat which inclination angle is indicated by the obtained seat tilting information, the inclination angle of the moving body which inclination angle is indicated by the obtained inclination information is within the range of the target values, the controller drives the rocking mechanism to execute rocking of the seat; and
in a case where it is determined, in the rocking range determination process, that the angle obtained by adding, to the inclination angle of the seat which inclination angle is indicated by the obtained seat tilting information, the inclination angle of the moving body which inclination angle is indicated by the obtained inclination information is outside the range of the target values, the controller executes an inclination angle adjusting process of adjusting the inclination angle of the seat.

9. A seat control method which controls a seat on which a passenger riding on a moving body sits, the seat control method comprising:
obtaining inclination information indicative of an inclination angle of the moving body, on which the seat is mounted, with respect to a contact surface; and
adjusting, on a basis of the obtained inclination information of the moving body, rocking of the seat by driving a rocking mechanism which is configured to rock the seat.
